(19) United States
(12) Patent Application Publication
(10) Pub. No.: US 2004/0173807 A1
(43) Pub. Date: Sep. 9, 2004

(54) Garnet phosphors, method of making the same, and application to semiconductor LED chips for manufacturing lighting devices

(76) Inventors: Yongchi Tian, Princeton, NJ (US); Diane Zaremba, Fairless Hills, PA (US); Perry Niel Yocom, Washington Crossing, PA (US)

Correspondence Address: Abhik A. Huq, Sarnoff Corporation, 201 Washington Road, Princeton, NJ, 08540, US

(21) Appl. No.: 10/664,712

(22) Filed: Sep. 17, 2003

Related U.S. Application Data
(60) Provisional application No. 60/451,737, filed on Mar. 4, 2003.

(51) Int. Cl. C09K 11/08

(52) U.S. Cl. 257/98; 252/301.4 R; 252/301.36; 427/157; 427/64

(57) ABSTRACT

A cerium-doped garnet phosphor including a second phase of an alkali metal or alkaline earth metal aluminate. The second phase imparts improved emission efficiency but without changing the wavelength of emission. These phosphors are useful to form a white light source together with a blue or ultraviolet light-emitting LED. The phosphors are applied to the LED by forming a phosphor slurry with a polymerizable material in a solution, coating the exposed surface of the LED with a predetermined amount of the slurry, and polymerizing the polymerizable material.

This application claims priority from Provisional Application Serial No. 60/451,737 filed Mar. 4, 2003.

This invention is directed to novel yellow-emitting yttrium aluminum garnet (YAG) phosphors, to a method of making these phosphors, and to their use together with light emitting diodes (LEDs) in manufacturing white light devices.

### BACKGROUND OF THE INVENTION

Yellow-emitting cerium doped yttrium aluminum garnet (YAG) phosphors have been known for some time. It is also known that the emission wavelength of these phosphors can be shifted to longer wavelengths when gadolinium is partially substituted for yttrium. Concomitantly, it was also found that larger ions partially substituted for aluminum shifted the emission wavelength to shorter wavelengths for these phosphors. Cerium-doped YAG phosphors generally emit in the 500-750 nm range, with a peak at 550 nm. The exact peak obtained depends on the concentration of Ce.

It is also known that these phosphors are useful as color converters for LEDs to make white light. A light emitting diode is used together with a phosphor coating that absorbs a part of the light emitted by the LED, thus emitting light of a different wavelength than that of the absorbed light. Ce:YAG phosphors have high luminance, and their stability over time is excellent.

U.S. Pat. Nos. 5,998,925 and 6,069,440 to Shimizu et al describe a white lighting device comprising a semiconductor blue light emitting diode of indium gallium nitride and gallium nitride coated with a yellow-emitting phosphor having the formula

(Re₁₋ᵣSmᵣ)₃(Al₁₋ₛGaₛ)₅O₁₂:Ce

wherein r is equal to or above 0 and less than 1, and s is equal to or above 0 and less than 1; and Re is one of yttrium (Y) and gadolinium (Gd). The phosphor is capable of absorbing part of the blue light from the diode and emitting light having a different wavelength than that of the absorbed light.

These phosphors can be made by dissolving Y, Gd and Ce in stoichiometric proportions in an acid, co-precipitating the solution with oxalic acid and firing the co-precipitate to obtain the oxide, mixing the fired oxide product with aluminum oxide and gallium oxide, mixing with an ammonium fluoride flux and firing in air at from 1350 to 1450 degrees C. for from about 2-5 hours.

However, it would be desirable to improve the efficiency of fluorescence emission in the phosphor but without changing the emission wavelength of YAG:Ce phosphors.

### SUMMARY OF THE INVENTION

We have found that by substituting barium fluoride, or other alkali metal or alkaline earth metal halide, as a flux during manufacture of a trivalent cerium activated, yellow emitting garnet phosphor, hereinafter a YAG:Ce phosphor, and heating the mixture at from 1400-1500° C., enhanced fluorescence emission is obtained, while maintaining the wavelength emission properties. The resultant phosphor has a small alkali metal or alkaline earth metal alumina halide crystalline second phase in the phosphor, generally about 1% which enhances its emission intensity in the yellow range. Thus the phosphor of the invention can be written as

Re₃(Al₁₋ₛGaₛ)₅O₁₂:Ce:xMAl₂O₄

wherein Re is a rare earth selected from the group consisting of yttrium, gadolinium, samarium, lutetium and yterbium; s is equal to or greater than 0 and less than or equal to 1; x is 0.01 to about 1.0%; and M is an alkali or alkaline earth metal.

We have also found that the flux material promotes the crystallization of the YAG phase when heated in the temperature range from 1400 to 1500° C. Thus the aluminate crystals co-exist in the phosphor, creating a second phase.

When the present phosphors are used in making solid state white lighting devices to produce white light, a blue LED is combined with a yellow-emitting phosphor. The phosphor is applied to an LED chip by mixing it with a polymerizable binder. A fixed amount of the phosphor-binder material is applied to the exposed face of the LED chip, and the binder is then polymerized to form a robust phosphor thin film directly on the LED. Polymerization can be carried out using photoinitiation or thermally induced polymerization.

Thus the present invention includes a new, two-phase phosphor; a method of making the two-phase phosphor; and a method of applying the phosphor in a controlled amount to produce a thin film that coats the surface of an LED to produce a white light device.

### BRIEF DESCRIPTION OF THE DRAWING

FIG. 1 is a graph of emission intensity versus wavelength for a phosphor of the invention fluxed with barium fluoride (A) and a phosphor fired without a flux (B).

FIG. 2 illustrates X-ray diffraction data of a YAG:Ce phosphor made with a barium fluoride flux showing the presence of a second phase of barium aluminate.

FIG. 3 is a schematic view of a suitable apparatus for applying the phosphor of the invention to an LED die.

FIG. 4A illustrates an LED die to be coated and FIG. 4B illustrates an LED die coated with a layer of the phosphor of the invention.

### DETAILED DESCRIPTION OF THE INVENTION

The amount of cerium present in a YAG phosphor depends on the atmosphere in which the precursor powder is fired. At 1450° C. in hydrogen, about 6 molar percent of cerium can be accommodated in the YAG lattice structure. At higher cerium concentrations, a perovskite phase appears, together with the garnet phase. The lattice parameter increases with increasing cerium concentration.

However, at 1450° C. in air, the solid solubility of cerium is only 2 molar percent, and a CeO₂ phase precipitates out. This phase diminishes the emission efficiency of the resultant phosphor.

The phosphor of the invention can be made according to the following steps:

a) Yttrium oxide (Y₂O₃) is dissolved in water by adding nitric acid. Cerium and aluminum nitrates are added to the yttrium solution.

b) A suitable acid or base is added to the solution to precipitate an yttrium salt. The mixture is heated at about 75° C. with stirring for about two hours.

c) Ammonium hydroxide is added to precipitate aluminum hydroxide, followed by heating at 75° C. for one to two hours. The mixture is allowed to cool overnight.

d) The supernatant liquid is decanted, and the precipitate centrifuged, then washed twice with acetone, and dried at about 80° C. for about four hours.

e) The precipitate is mixed with an alkali or alkaline earth metal halide, such as barium fluoride, and fired in a tube furnace in air at about 1350-1450° C. for about 1-5 hours, preferably about 2-3 hours.

The following examples set forth details of the method of making the YAG:Ce phosphors of the invention. However, the invention is not meant to be limited to the details described therein.

### EXAMPLE 1

A weighed amount of yttrium oxide is dissolved in water by adding nitric acid.

About a 10% by weight excess of aluminum as its nitrate, was added to the yttrium solution.

Yttrium, aluminum and cerium are then precipitated out of solution with ammonium hydroxide, followed by heating at about 75° C. with stirring for about two hours.

The supernatant liquid is decanted off, the solids are centrifuged, washed twice with acetone, and dried at 80° C. for about four hours.

The resultant solids were fired with barium difluoride (BaF₂) in air for two hours.

FIG. 2 illustrates X-ray diffraction data of the YAG:Ce phosphor. The diffraction pattern clearly shows the peaks of the second phase barium aluminate (BaAl₂O₄).

Control 1

The procedure of Example 1 was followed except that the dried solids were fired with YF₃ at 1450° C. for 2.5 hours in air.

Control 2

Yttrium oxide was dissolved in water by adding nitric acid. Ten weight percent above the stoichiometric amount of aluminum nitride was added to the yttrium solution.

The yttrium and aluminum salts were precipitated with oxalic acid at a pH of about 3; if needed, ammonium hydroxide can be added to aid in the precipitation. The mixture was heated at about 75° C. for two hours.

Aluminum hydroxide was precipitated by adding ammonium hydroxide, followed by heating at 75° C. while stirring for one hour. The mixture was cooled overnight.

The supernatant liquid was decanted and the remainder centrifuged. The solids were washed twice with acetone and dried at about 80° C. for four hours.

The solids were fired with ammonium fluoride (NH₄F) for two hours in air.

Control 3

The procedure of Example 1 was followed except that no flux was used during the firing step.

This phosphor is more crystalline than those made according to the invention.

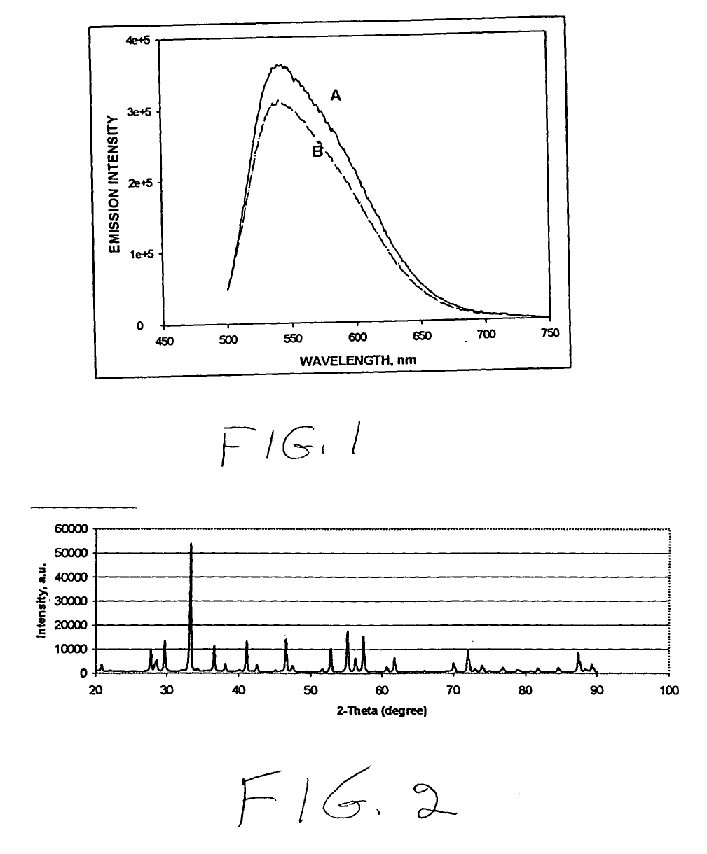

FIG. 1 illustrates X-ray diffraction data comparing the YAG:Ce phosphor made in accordance with Example 1 (A) and the phosphor made in accordance with Control 3 (B). The emission intensity of the YAG:Ce of the invention is higher. The emission wavelength is about 530 nm.

The present phosphors are useful for making solid state lighting devices that emit white light.

To produce white light, a high energy light from a semiconductor LED that emits blue or ultraviolet light is used as a pumping source to excite a phosphor layer. The phosphor layer must absorb the LED light, and then it re-emits light at a lower energy, or a longer wavelength.

Three types of LED white light devices are known; a) a blue LED and a yellow phosphor; b) a blue LED and combined red and green emitting phosphors; and c) a UV light emitting LED combined with blue, green and red-emitting phosphors. The phosphor layer is coated onto the exterior surface of the LED so that no air gap exists between the LED and the phosphor layer, and the phosphor must form a mechanically robust film on the LED surface, sufficient to maintain its structure during packaging and use.

In accordance with the present method of preparing a suitable white light source, the phosphor is ground to a particle size of about 1-15 microns if required; a slurry is prepared of one or more of the phosphor powders and a binder solution of a polymer or a polymerizable material, together with a dispersion liquid in which the polymer or polymerizable material is soluble. This dispersion liquid can be water, ethanol or other suitable organic solvent. A controlled amount of the slurry is applied to the LED die in a predetermined amount sufficient to coat the die; then the binder is polymerized to form a thin phosphor-containing film on the die.

The binder can be polyvinyl alcohol (PVA) for example, mixed with a fluid medium in which the phosphor is soluble if desired. The binder can be polymerized by photo-initiation or with heat.

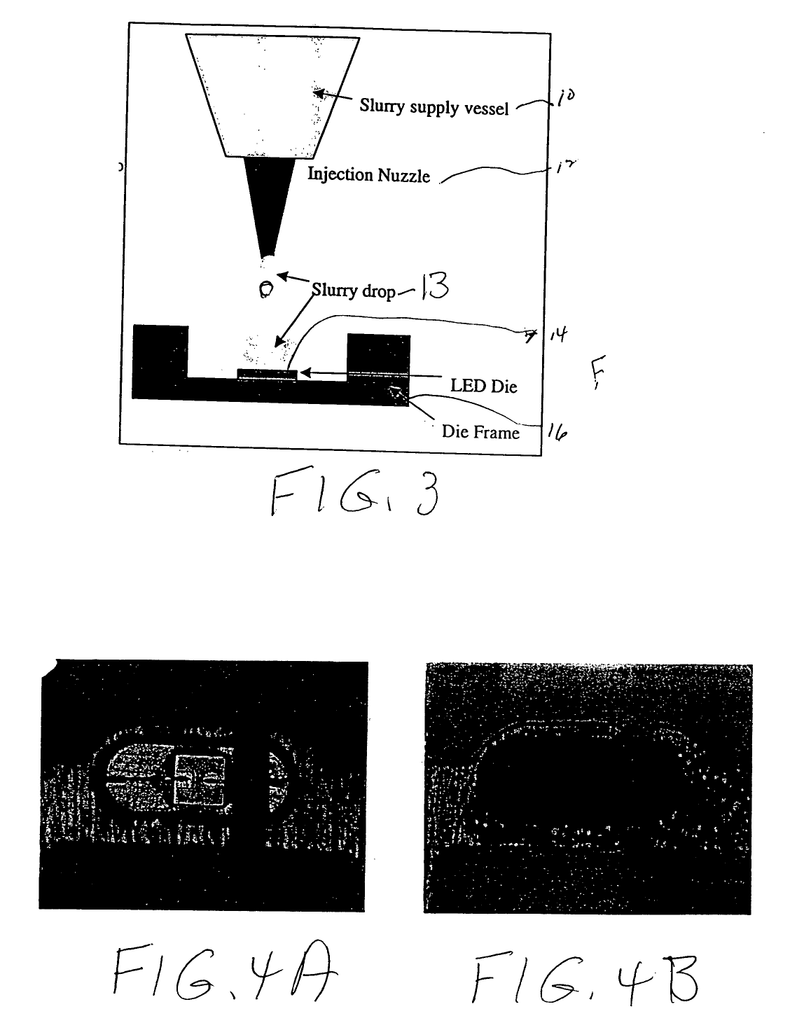

FIG. 3 illustrates a suitable apparatus for applying the slurry-binder mixture to an LED die. Referring to FIG. 6, a slurry supply vessel 10 has an injection nozzle 12 that provides a predetermined amount of the phosphor-binder slurry as a drop 13 to the LED die 14. The LED die 14 is mounted on a die frame 16.

Alternately, the required amount of phosphor slurry can be applied by inkjet printing.

The following method is suitable for applying a phosphor slurry onto an LED die.

1) An aqueous solution of polyvinyl alcohol (PVA) is made by adding 5 grams of PVA powder to 200 ml of water. The mixture is heated to 85° C. with stirring for one hour, then cooled to room temperature, and refrigerated at 2° C. overnight.

2) YAG:Ce (0.75 gram) having a particle size of from about 2-9 microns, is added to 1.5 ml of the above solution, and shaken for 5 minutes to form a phosphor slurry.

3) The slurry is applied with a microsyringe or an injection nozzle to each of a plurality of LED dies on a lead frame board. The typical volume of the phosphor slurry applied to each die can be about 1.5 microliters.

4) The die are baked in an oven at 130° C. for 5 minutes to polymerize the binder.

FIG. 4A illustrates an LED to be coated. FIG. 4B illustrates a phosphor coated LED as prepared above.

Although the invention has been described in terms of specific embodiments, one skilled in the art can readily substitute other phosphors and dopants as described, other binders, and the like. The invention is only meant to be limited by the scope of the appended claims.

We claim:

1. A garnet phosphor having the following composition:
Re₃(Al₁₋ₛGaₛ)₅O₁₂:Ce:xMAl₂O₄
wherein Re is a rare earth selected from the group of yttrium, gadolinium, samarium, lutecium and ytterbium, s is equal to or greater than 0 and less than or equal to 1; x is from 0.01 to 0.3, and M is an alkali or alkaline earth metal.

2. A garnet phosphor according to claim 1 wherein Re is selected from the group consisting of yttrium and gadolinium.

3. A garnet phosphor according to claim 1 wherein x is from about 0.01 to about 1%.

4. A garnet phosphor according to claim 1 wherein M is selected from the group consisting of alkali and alkaline earth metals.

5. A garnet phosphor according to claim 4 wherein M is barium.

6. A method of making a phosphor slurry comprising making a solution of a polymer or polymerizable material in a dispersion liquid, cooling it, adding a YAG:Ce phosphor powder and shaking to form a uniform slurry.

7. A method according to claim 6 wherein the phosphor particles are from 1-15 microns in size.

8. A method according to claim 6 wherein the polymerizable material is polyvinyl alcohol.

9. A method according to claim 6 wherein the dispersion liquid is water.

10. A method according to claim 6 wherein the polymerizable material is heated to polymerize it.

11. A method according to claim 6 wherein the polymerizable material is polymerized with light.

12. A white light source comprising a blue-emitting LED coated with a layer of the phosphor of claim 1 embedded in a polymer.

13. A white light source comprising an ultraviolet light LED combined with red, green and blue emitting phosphors, wherein the green emitting phosphor has the formula of claim 1.

14. A method of making a white light source comprising
a) forming a slurry of a phosphor of claim 1 in a binder solution comprising a polymerizable material in a dispersion liquid in which the polymerizable material is soluble;
b) mounting one or more semiconductor light emitting diodes that emit blue light on a frame;
c) coating the light emitting diodes with a predetermined amount of the phosphor slurry; and
d) polymerizing the polymerizable material.

15. A method according to claim 14 wherein the polymerizable material is polyvinyl alcohol.

16. A method according to claim 14 wherein the polymerizable material is polymerized with heat.

17. A method according to claim 16 wherein the polyvinyl alcohol is polymerized by heating at about 130° C.

18. A method according to claim 14 wherein the polymerizable material is polymerized by photoinitiation.
